(19) United States
(12) Patent Application Publication
(10) Pub. No.: US 2007/0079046 A1
(43) Pub. Date: Apr. 5, 2007

(54) Multiprocessor system

(75) Inventors: Shan-Kai Yang, Taipei (TW); Shi-Jun Ni, Shanghai (CN); Jian Shen, Shanghai (CN); Lei Ding, Shanghai (CN); Hai-Ming Ding, Shanghai (CN); Fang Yuan, Shanghai (CN)

Correspondence Address: BACON & THOMAS, PLLC, 625 SLATERS LANE, FOURTH FLOOR, ALEXANDRIA, VA, 22314, US

(73) Assignee: TYAN COMPUTER CORP., Taipei (TW)

(21) Appl. No.: 11/346,312

(22) Filed: Feb. 3, 2006

(30) Foreign Application Priority Data
Sep. 30, 2005 (TW) 094134285

(51) Int. Cl. G06F 13/00

(52) U.S. Cl. 710/316

(57) ABSTRACT

A multiprocessor system is disclosed, which comprises a plurality of processor unit, such as eight processor units, and a plurality of interconnection bus that may be a dual unidirectional point-to-point bus. Every interconnection bus connects predetermined two of the processor units. Particularly, at least two of the interconnection buses are crossed to each other.

### CROSS-REFERENCE

This application is based upon and claims the benefit of priority from prior Taiwanese Patent Application No. 094134285, filed on Sep. 30, 2005. The prior application is herewith incorporated by reference in its entirety.

### BACKGROUND OF THE INVENTION

1. Field of the Invention

The present invention relates to a processor system, and more particularly, to a multiprocessor system for shortening latency.

2. Description of the Related Art

Latency is a very important point in a multiprocessor system because it can hugely affect the speed of processing and transmitting. As the design of such multiprocessor systems evolves, and as the technology available for that design becomes more complex, limits on the construction of such systems are encountered. One such limit involves the configuration size of the multiprocessor system itself.

In general, latency in the multiprocessor system is defined as: “the minimum buses to be passed for communicating between any two processor units. For example, referring to FIG. 1, the latency equals to one for communicating between processor unit 14a and processor unit 14b. Furthermore, the latency in the prior art of a multiprocessor system 1 is four for communicating between processor unit 14a and processor unit 14h.

Nowadays, the bus communication can use HyperTransport™ (HT) technology, which is a dual unidirectional point-to-point serial/parallel high-bandwidth and low-latency computer bus. The HT specification is clearly defined and maintained by the HT Consortium for promoting and developing HT technology. HT technology's aggregate bandwidth of 22.4 GB/sec represents better than a 70-fold increase in data throughput over PCI buses. While providing far greater bandwidth, HT technology complements legacy I/O standards like PCI as well as emerging technologies like PCI-X and PCI-Express. HT technology may provide a flexible, scalable interconnect architecture designed to reduce the number of buses within the multiprocessor system.

At most, each processor unit 14a-14h, such as AMD Opteron™ MP, is able to support three dual unidirectional point-to-point buses. As a result, according to the feature of the processor unit, it should have a better performance for a multiprocessor system that may be improved to reduce latency.

### SUMMARY OF THE INVENTION

A main objective of the present invention is to provide a multiprocessor system that can have lower latency.

The present invention provides a multiprocessor system, which comprises a plurality of processor unit, such as eight processor units, and a plurality of interconnection bus. Every interconnection bus connects predetermined two of the processor units. Particularly, at least two of the interconnection buses are crossed to each other. Preferably, the interconnection bus is a dual unidirectional point-to-point bus, which may be defined as a HyperTransport™ (HT) bus.

Since each processor unit, such as AMD Opteron™ MP, is able to support three dual unidirectional point-to-point buses, a largest latency between two processor units according to the present invention can be reduced to three. Each processor unit further comprises a route logic for routing a data stream. Thus, the data stream can be routed to a suitable processor unit that can reduce the latency between two processor units. It is achievable for each interconnection bus to be connected between predetermined two of the processor units.

The multiprocessor system according to this invention may further comprise an outward-connection bus for communication between one of the processor units and a bridge chipset, such as a south bridge, a north bridge, or the like. Similarly, the outward-connection bus may be a dual unidirectional point-to-point bus. Furthermore, the outward-connection bus can also be defined as a HyperTransport™ (HT) bus.

In a different embodiment, the present invention provides a multiprocessor system comprising two groups of processor units and a plurality of interconnection bus, wherein every interconnection bus connects predetermined two of the processor units. Particularly, at least two of the interconnection buses are crossed to each other.

Preferably, the multiprocessor system according to this invention may further comprise a card interface for providing connection between the two groups of processor units. Each group comprises four processor units.

Similarly, the multiprocessor system in this embodiment may further comprise an outward-connection bus for communication between one of the processor units and a bridge chipset.

The interconnection bus, the connection bus, or the outward-connection bus may respectively be a dual unidirectional point-to-point bus, which can be defined as a HyperTransport™ (HT) bus. In this embodiment, similarly, each processor unit, such as AMD Opteron™ MP, is able to support three dual unidirectional point-to-point buses, so that a largest latency between two processor units according to the present invention can be reduced to three.

In this embodiment, one group of the processor units is configured on a main board, and another group of the processor units is configured on an expansion board. A card interface is provided for communication between the main board and the expansion board. The card interface comprises a connection bus that is a dual unidirectional point-to-point bus for communication between the main board and the expansion board.

### BRIEF DESCRIPTION OF THE DRAWINGS

FIG. 1 is a schematic view illustrating a conventional 8-way processing system according to the prior art.

FIG. 2A-2F are schematic views illustrating different embodiments of the multiprocessor system according to the present invention.

FIG. 3 is a schematic view illustrating a multiprocessor system comprising route logic in each processor unit according to the present invention.

FIG. 4 is a schematic view illustrating a multiprocessor system comprising a plurality of group of processor unit to communicate with each other by way of a plurality of interconnection bus according to the present invention.

### DETAILED DESCRIPTION OF THE PREFERRED EMBODIMENT

Other objects, advantages, and novel features of the invention will become more apparent from the following detailed description when taken in conjunction with the accompanying drawings.

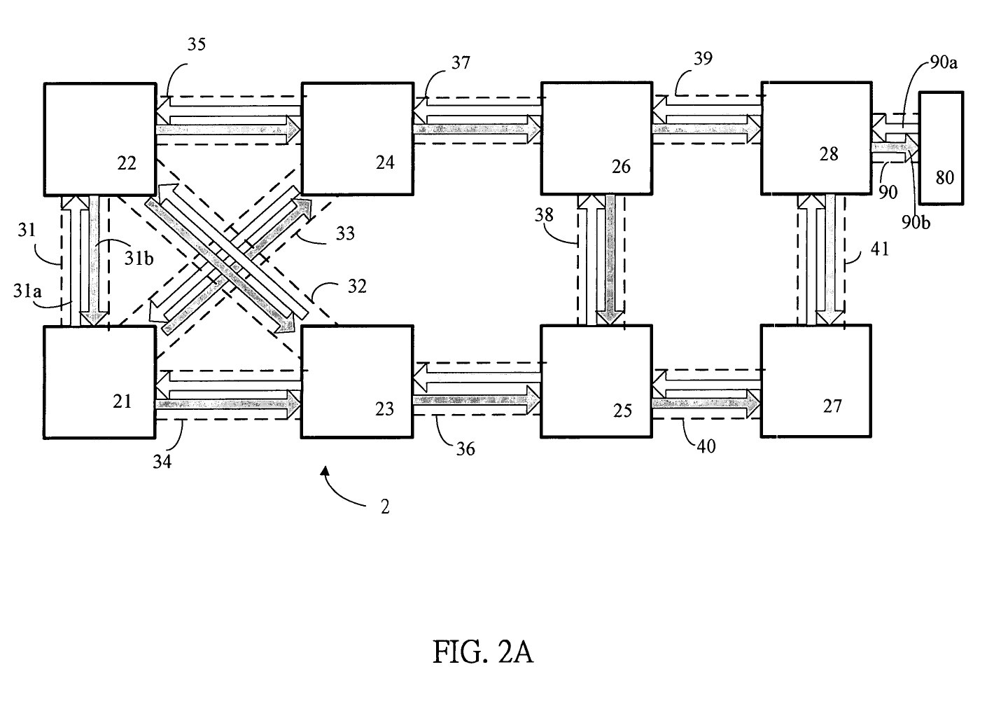

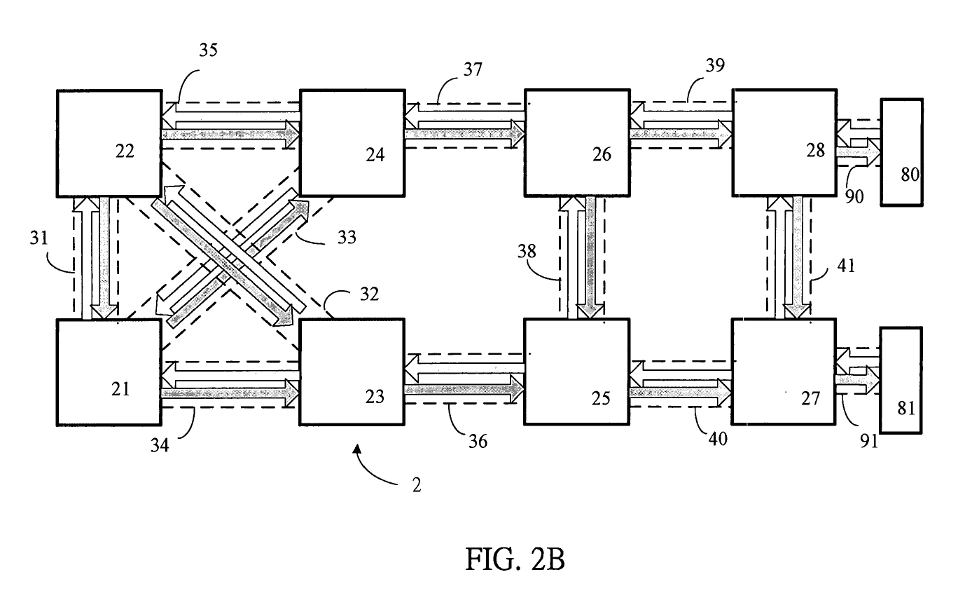

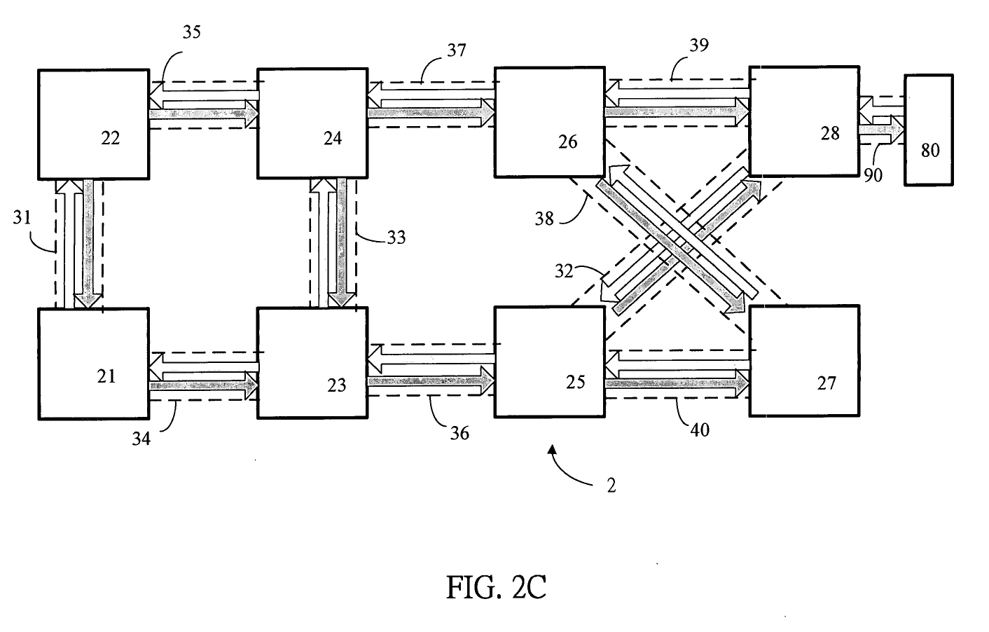

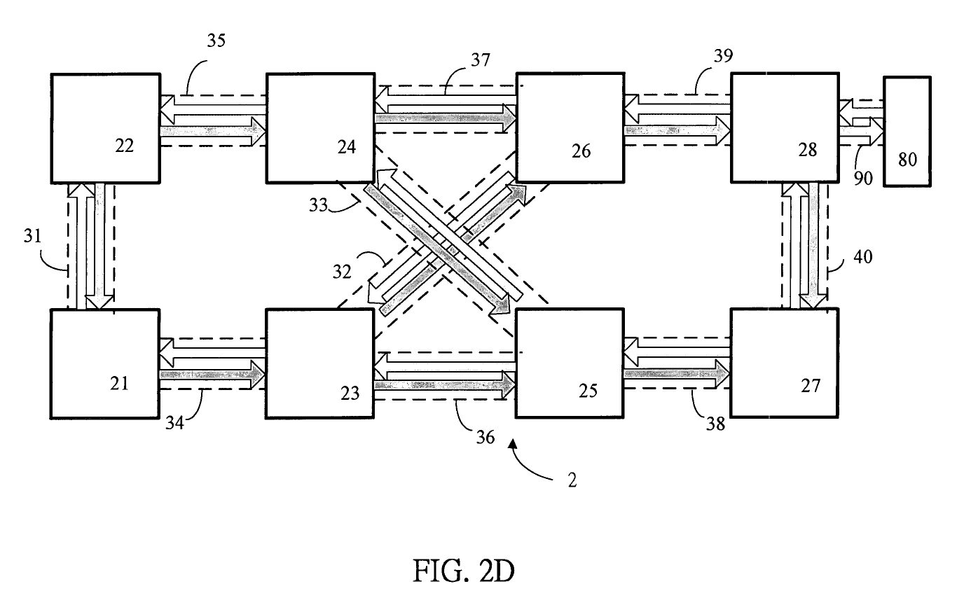

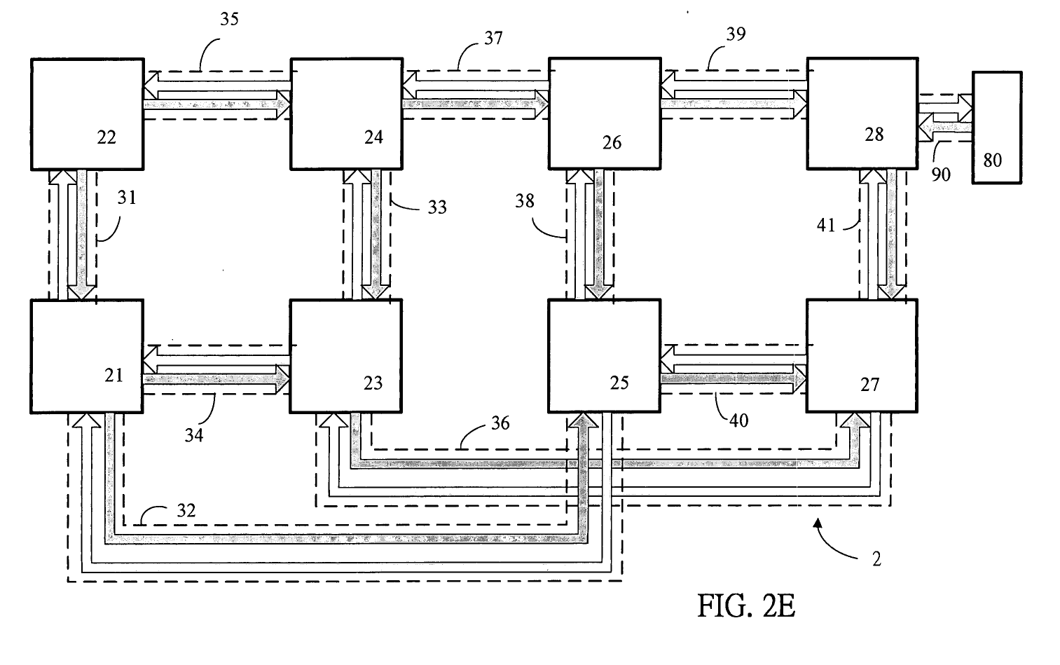

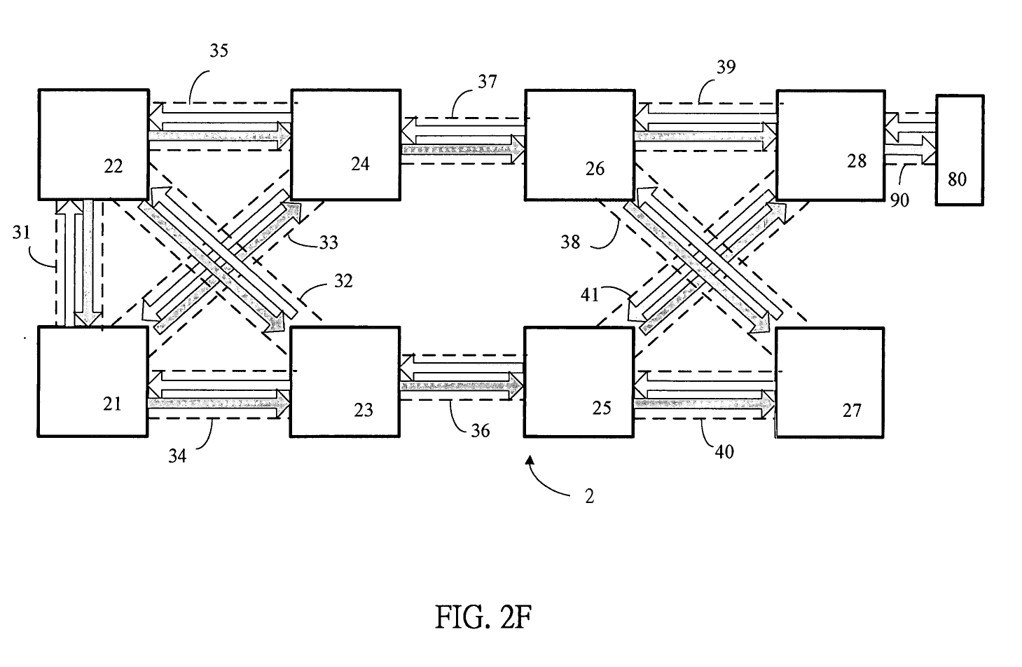

Please refer to FIG. 2A. The present invention provides a multiprocessor system 2, which comprises a plurality of processor unit 21-28, such as total eight processor units, and a plurality of interconnection bus 31-41. Preferably, each interconnection bus 31-41 is a dual unidirectional point-to-point bus, which may be respectively defined as a HyperTransport™ (HT) bus. Thus, it can save time for waiting for communication since the interconnection bus 31 of the dual unidirectional point-to-point bus may comprise a receiving bus 31a and a transmitting bus 31b (or a receiving bus 31b and a transmitting bus 31a) separately.

Every interconnection bus 31-41 is provided for connecting between predetermined two of the processor units; such as the processor unit 21 and the processor unit 22 connect to each other by the interconnection bus 31. Particularly, according to the present invention, at least two of the interconnection buses are crossed to each other; such as the interconnection bus 32 and the interconnection bus 33 show in FIG. 2A are crossed to each other.

The multiprocessor system 2 according to this invention may further comprise an outward-connection bus 90 for communication between the processor unit 28 and a bridge chipset 80, such as a south bridge, a north bridge, or the like. Similarly, the outward-connection bus 90 is a dual unidirectional point-to-point bus, which may comprise a receiving bus 90a and a transmitting bus 90b (or a receiving bus 90b and a transmitting bus 90a) separately. Furthermore, the outward-connection bus 90 can also be defined as a HyperTransport™ (HT) bus.

It should be understood that FIG. 2A is not used to limit the present invention. Please refer to FIG. 2B, the processor unit 27 my also communicate with another interface device 81, such as another chipset, by way of the outward-connection bus 91. In addition, referring to FIG. 2C-FIG. 2E, which show that the crossed interconnection buses 32 and 38 in FIG. 2C or interconnection buses 32 and 33 in FIG. 2D or interconnection buses 32 and 36 in FIG. 2E can be designed between different processor units 25, 28, 26 and 27 in FIG. 2C, processor units 23, 26, 24 and 25 in FIG. 2D or processor units 21, 25, 23 and 27 in FIG. 2E, only if each processor unit 21-28 is connected with less than three interconnection buses. In another word, each processor unit, such as AMD Opteron™ MP, is able to support three dual unidirectional point-to-point buses, so that a largest latency between two processor units according to the present invention can be reduced to three in this preferred embodiment.

For example, when the processor unit 28 needs to communicate with the processor unit 21, the processor unit 28 has to communicate with the processor unit 26 first, and then the processor unit 24 and the processor unit 21 sequentially. That is, the communication between the processor unit 28 and 21 has to pass the interconnection bus 39, 37, and 33. According to the present invention, therefore, the largest latency in the multiprocessor system 2 with total eight processor units 21-28 can be reduced to three.

Referring to FIG. 2F, it shows two crossed interconnection buses 32, 33 and 38, 41. It should be known to those skilled in this art that the path of the interconnection bus 31-41 is able to be designed or changed by a multilayer printed circuit board (PCB).

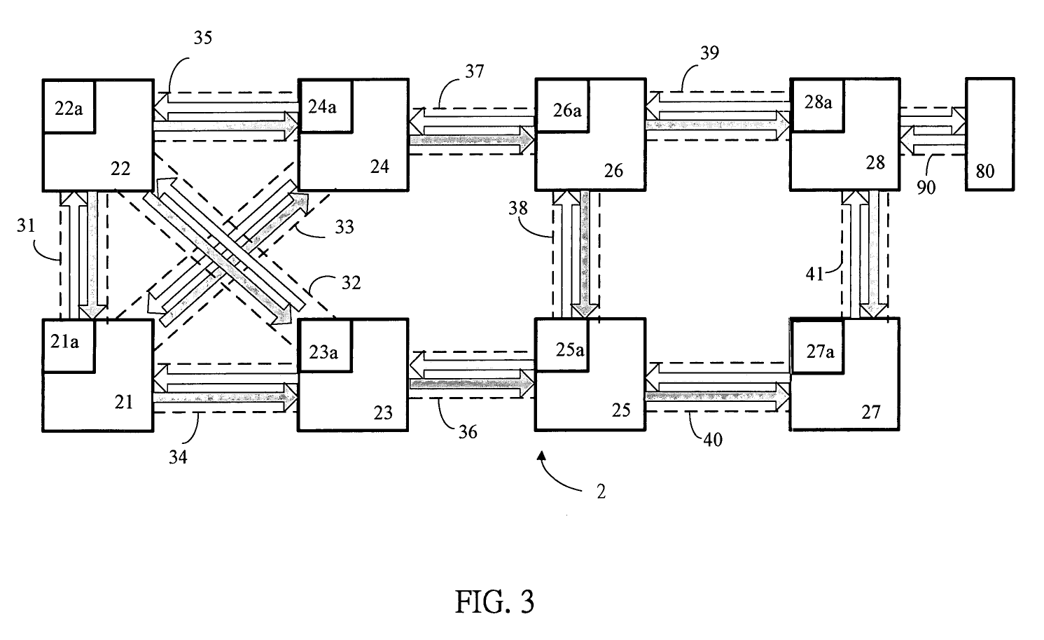

Please refer to FIG. 3. In a preferred embodiment, each processor unit 21-28 further comprises a route logic 21a-31a respectively for routing a data stream. Furthermore, the route logic 21a-31a is programmable. Thus, the data stream can be routed to a suitable processor unit that can reduce the latency between any two of the processor units 21-28.

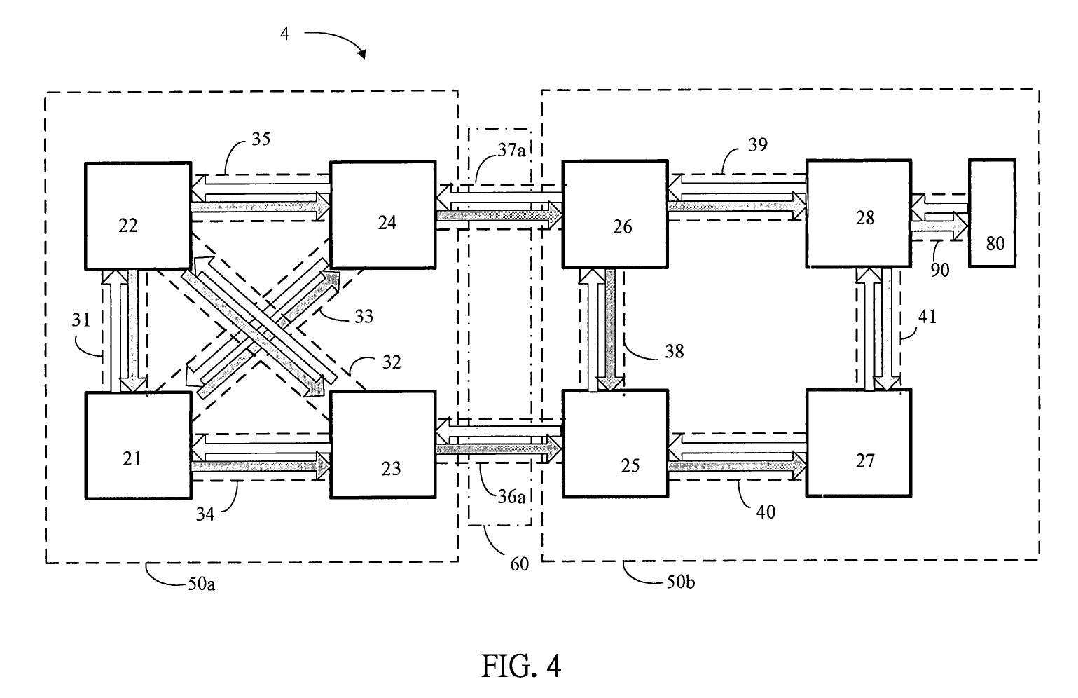

One of preferred embodiment according to this invention, referring to FIG. 4, it provides a multiprocessor system 4 comprising two groups of processor units 21-28 and a plurality of interconnection bus 31-35, 38-41. One group comprises the processor units 25-28, and another group comprises the processor units 21-24. For example, physically, the processor units 25-28 can be comprised in a main board 50b of a server (not shown). The processor units 21-24 can be comprised in an expansion board 50a of a server (not shown). Moreover, the communication between the main board 50b and the expansion board 50a can be built by a card interface 60 to provide connection buses 36a, 37a for providing connection between the group of processor units 21-24 and the group of processor units 25-28.

Every interconnection bus 31-41 connects predetermined two of the processor units 21-28. For example, the processor unit 21 and the processor unit 22 are connected to each other through the interconnection bus 31. Particularly, in this invention, at least two of the interconnection buses 32 and 33 are crossed to each other.

In addition, the connection buses 36a, 37a shown in FIG. 4 are not crossed to each other. However, those skilled in this art should know that the connection buses 36a, 37a is able to be designed to cross to each other by a multilayer PCB.

Similarly, the multiprocessor system 4 in this embodiment may further comprise an outward-connection bus 90 for communication between the processor unit 28 and a bridge chipset 80, such as a south bridge, a north bridge, or the like.

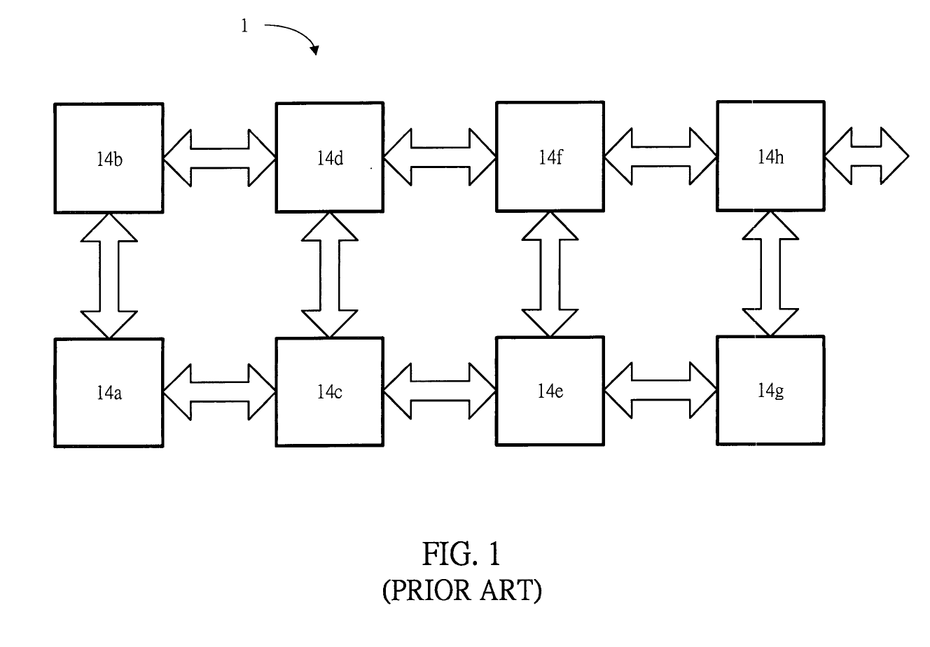

The interconnection bus 31-35, 38-41, the connection bus 36a and 37a, or the outward-connection bus 90 may be a dual unidirectional point-to-point bus respectively, as described in above, for receiving and transmitting respectively, which can be defined as a HyperTransport™ (HT) bus. In this embodiment, similarly, each processor unit 21-28, such as AMD Opteron™ MP, is able to support three bidirectional buses or three dual unidirectional point-to-point buses, a largest latency between two processor units, such as processor unit 21 and processor unit 28, according to the present invention can be reduced to three comparing with the prior art shown in FIG. 1.

Although the present invention has been explained in relation to its preferred embodiment, it is to be understood that many other possible modifications and variations can be made without departing from the spirit and scope of the invention as hereinafter claimed.

What is claimed is:

1. A multiprocessor system, comprising:
a plurality of processor units; and
a plurality of interconnection buses connecting respectively between predetermined two of the processor units;
wherein at least two of the interconnection buses are crossed to each other.

2. The multiprocessor system as claimed in claim 1, wherein the interconnection bus is a dual unidirectional point-to-point bus.

3. The multiprocessor system as claimed in claim 2, wherein the interconnection bus is defined as a HyperTransport™ (HT) bus.

4. The multiprocessor system as claimed in claim 1, wherein the number of the processor unit is eight.

5. The multiprocessor system as claimed in claim 4, wherein a largest latency between any two of the processor units is three.

6. The multiprocessor system as claimed in claim 1, wherein each processor unit further comprises a route logic for routing a data stream.

7. The multiprocessor system as claimed in claim 1 further comprising an outward-connection bus for communication between one of the processor units and a bridge chipset.

8. The multiprocessor system as claimed in claim 7, wherein the outward-connection bus is a dual unidirectional point-to-point bus.

9. The multiprocessor system as claimed in claim 7, wherein the outward-connection bus is defined as a HyperTransport™ (HT) bus.

10. A multiprocessor system, comprising:
two groups of processor units; and
a plurality of interconnection buses connecting respectively between predetermined two of the processor units;
wherein at least two of the interconnection buses are crossed to each other.

11. The multiprocessor system as claimed in claim 10 further comprising a card interface for providing connection between the two groups of processor units.

12. The multiprocessor system as claimed in claim 11, wherein the card interface comprises a connection bus that is a dual unidirectional point-to-point bus.

13. The multiprocessor system as claimed in claim 12, wherein the connection bus is defined as a HyperTransport™ (HT) bus.

14. The multiprocessor system as claimed in claim 10, wherein each group comprises four processor units.

15. The multiprocessor system as claimed in claim 10, wherein the interconnection bus is a dual unidirectional point-to-point bus.

16. The multiprocessor system as claimed in claim 15, wherein the interconnection bus is defined as a HyperTransport™ (HT) bus.

17. The multiprocessor system as claimed in claim 10, wherein a largest latency between two processor units is three.

18. The multiprocessor system as claimed in claim 10 further comprising an outward-connection bus for communication between one of the processor units and a bridge chipset.

19. The multiprocessor system as claimed in claim 18, wherein the outward-connection bus is a dual unidirectional point-to-point bus.

20. The multiprocessor system as claimed in claim 19, wherein the outward-connection bus is defined as a HyperTransport™ (HT) bus.

21. The multiprocessor system as claimed in claim 10, wherein one of the two groups of the processor units is configured on a main board.

22. The multiprocessor system as claimed in claim 10, wherein one of the two groups of the processor units is configured on an expansion board.
